(19) United States
(12) Patent Application Publication
(10) Pub. No.: US 2026/0090591 A1
(43) Pub. Date: Apr. 2, 2026

(54) Exhalation Valve for Mask

(71) Applicant: Louis M. Gerson Co., Inc., Middleboro, MA (US)

(72) Inventor: Rahilkhan Pathan, South Easton, MA (US)

(21) Appl. No.: 18/899,722

(22) Filed: Sep. 27, 2024

(51) Int. Cl. A41D 13/11; A62B 9/02

(52) U.S. Cl. CPC A41D 13/1146; A62B 9/02

(57) ABSTRACT

An exhalation valve includes a body and a cantilevered diaphragm having a clamped region and a valve face. The diaphragm's clamped region is clamped at the valve's body but the valve face deforms in response to the exhalation pressure. A valve seat on the valve body faces the valve face. The vanes cause a pressure field that results from the exhalation pressure. Its average pressure gradient points toward the valve seat and the region of the valve face that defines the longest moment arm. Normally, the valve face contacts the valve seat and closes the exhalation valve. In response to exhalation-induced torque above the threshold, it lifts off the valve seat and opens the exhalation valve.

### BACKGROUND

Face masks and filtering face pieces (“respirators”) are often fitted with an exhalation valve. An exhalation valve works like a check valve. It opens when a wearer exhales and closes when the wearer inhales. This creates a unidirectional breathing path.

The exhalation valve promotes comfort in two ways.

First, by rapidly venting exhaled air, the exhalation valve reduces buildup of exhaled air within the respirator's interior compartment. This exhaled air is hot, humid, and laden with carbon dioxide. Evacuation of this exhaled air from the interior of the mask improves wearer comfort and health.

The buildup of carbon dioxide in the respirator's interior compartment potentially reduces the oxygen intake. This can lead to an inadequate level of invigoration. Recent studies have highlighted the potential risks associated with prolonged mask usage, particularly concerning carbon dioxide accumulation. This is particularly pronounced with N95 masks. As is documented at https://www.ncbi.nlm.nih.gov/pmc/articles/PMC9981272/, such masks have been shown to result in higher CO2 accumulation due to their design and filtering efficiency.

In the United States, The National Institute of Occupational Safety and Health (NIOSH) specifies the quality systems and test protocols for issuing an Approval under 21 CFR 84 for a respiratory protection products. The portion of this test protocol for measuring exhalation pressure specifies that single exhalation valves be tested at a flow rate of eighty-four liters per minute, which is considered a breathing rate for high-exertion activities. Other studies, such as the “The Physics of Human Breathing: Flow, Timing, Volume and Pressure Parameters for Normal on-demand and Ventilator Respiration (Piel et al, Volume 15 Number 4, Journal of Human Breath Research) have determined that a rate of breathing for moderate activity is forty liters per minute. These studies can be viewed at https://iopscience.iop.org/article/10.1088/1752-7163/ac2589 and at https://www.ncbi.nlm.nih.gov/pmc/articles/PMC8672270/]

Second, the open pathway means that the wearer experiences low breathing resistance during exhalation. This breathing resistance is much lower than that which the wearer would experience when attempting to exhale through the mask's filtering fabric or through a respirator that lacks an exhalation valve. Although the reduction in breathing resistance only occurs during exhalation, this is nevertheless a significant advantage. It turns out that, given the same breathing resistance, humans perceive exhalation as more uncomfortable than inhalation.

### SUMMARY

In one aspect, the invention features an exhalation valve that remains closed until opened in response to exhalation pressure caused by a pulse of exhaled air. Such a valve includes a cover, a base that engages the cover, a valve body that is between the cover and the base, and a cantilevered diaphragm having a clamped region and a valve face. The valve face has plural regions, each of which defines a moment arm. Among these regions is a particular region that defines a moment arm that is longer moment arms of all other regions. The clamped region is clamped at the valve body but the valve face is free to deform in response to the exhalation pressure. The valve body comprises: a valve seat that is disposed on the valve body and that faces the valve face. It also includes vanes configured to cause a pressure field that results from the exhalation pressure. This pressure field has an average pressure gradient that points toward the valve seat and the particular region of the valve face. In the absence of exhalation-induced torque at the valve face that is above a threshold, the valve face contacts the valve seat and closes the exhalation valve. But, in response to exhalation-induced torque above the threshold, the valve seat lifts off the valve seat and opens the exhalation valve.

In some embodiments, the clamped region surrounds a hole in the diaphragm. Among these are embodiments in which the valve face is disposed along the diaphragm's periphery. Embodiments include those in which the periphery is a circumference and those in which the periphery is a perimeter.

In other embodiments, the valve body comprises a spindle having a shaft and an annular ledge around the shaft. In such embodiments, the base forms a receptacle that receives the shaft and the diaphragm is clamped between the annular ledge and a distal end of the receptacle.

Other embodiments include those in which the vanes are annular vanes that are concentric with each other and those in which the vanes follows a path that, when projected on the diaphragm, results in a closed path on the diaphragm.

In some embodiments, the vanes comprise a cross section having a leading edge and a trailing edge, wherein the trailing edge is closer to the diaphragm than the leading edge. In others, each of the vanes has a cross section having a major axis and a minor axis, wherein the major axis is disposed along a direction that has a component that is directed toward the diaphragm.

Further embodiments include those in which vanes are annular vanes having trailing edges and leading edges, the latter being tangent to a common plane and those in which each of the vanes is separated from the diaphragm by a vertical distance, but with the vertical distances being non-uniform.

In still other embodiments, a first vane is closer to the valve face than a second vane. In such embodiments, the first vane is separated from the diaphragm by a first distance and the second vane is separate from the diaphragm by a second distance that is greater than the first distance. In still other embodiments, the vanes that are closer to the valve seat are also closer to the diaphragm.

Embodiments further include those in which the vanes are oriented to prevent exhaled air from impinging directly on the diaphragm and those in which the vanes are oriented to direct exhaled air away from the clamped region of the diaphragm, those in which the vanes are configured to cause exhaled air to travel towards those moment arms that are the longest of the plurality of moment arms, each of the moment arms being a moment arm of one of the regions of the diaphragm, those in which the vanes are configured to direct exhaled air to maximize torque applied to the valve face, those in which the vanes are configured to increase density of exhaled air at a periphery of the valve body, and those in which the vanes are configured to increase density of exhaled air at the particular region.

Also among the embodiments is one in which the vanes comprise leading edges that are aligned to be coplanar with a horizontal plane and trailing edges that are aligned to follow a convex surface. Examples of convex surfaces include sections of a paraboloid, a sphere, an ellipsoid, and a catenary curve of revolution.

Still other embodiments include those in which the vanes have edges that delineate a cylindrical volume formed by a cylindrical section bounded by a plane perpendicular to an axis of the cylindrical section and by a concave surface.

Embodiments include diaphragms of varying footprints, including circular diaphragms, oval diaphragms, and polygonal diaphragms, including square diaphragms, rectangular diaphragms, and weighted superpositions of any of the foregoing diaphragms.

Still other embodiments include a face mask, with any of the foregoing exhalation valves being integrated into or disposed on the mask such that the exhalation pressure results from respiration by a person who is wearing the face mask.

In some embodiments, the clamped region surrounds a central clamping member in the diaphragm and the valve face is disposed along a periphery of the diaphragm.

In other embodiments, the particular region comprises a periphery of the diaphragm.

In another aspect, the invention features a mask and an exhalation valve disposed on the mask. The exhalation valve, which opens in response to exhalation pressure caused by exhalation into the mask, includes means for housing a valve body and a cantilevered diaphragm having a flexible periphery. The valve body comprise means for directing exhaled air towards the periphery of the diaphragm.

These and other features of the invention will be apparent from the following detailed description and the accompanying figures, in which:

### BRIEF DESCRIPTION OF THE FIGURES

FIG. 1 shows a mask with an exhalation valve;

FIG. 2 is an isometric view of an exhalation valve for use with the mask shown in in FIG. 1

FIG. 3 is another isometric view of the exhalation valve shown in FIG. 2;

FIG. 4 shows a cross-section of the exhalation valve shown in FIG. 2; and

FIG. 5 shows a cross-section of an alternative embodiment of the exhalation valve shown in FIG. 2.

### DETAILED DESCRIPTION

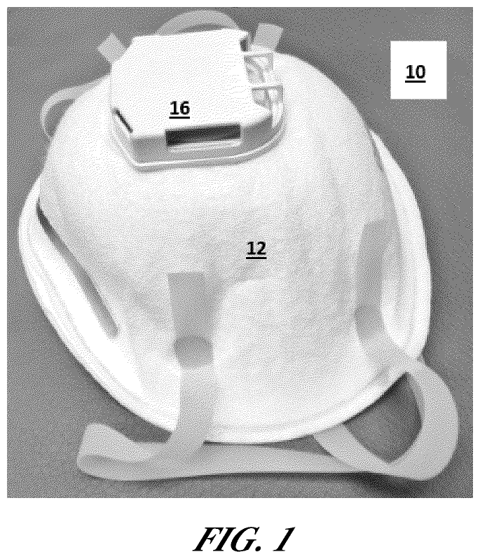

FIG. 1 shows a mask 10 having a fabric shell 12 and an exhalation valve 16 positioned at a central portion of the mask 10. The fabric shell 12 is fabricated from a multilayered nonwoven material. Examples of suitable materials for the fabric shell 12 include spunbond, or air laid, or wet laid, or needle punched polyester or polypropylene staple fiber webs appropriate for the construction style of the mask, together with filter material such as melt-blown, nanofiber, membrane, staple fiber, needle-punched staple fiber, or fiberglass material.

The mask 10 includes one or more headband straps for holding the mask 10 over the wearer's mouth and nose. In some embodiments, the mask's body is made from an elastomeric material, examples of which include a thermoplastic elastomer, silicone rubber, EPDM and a rubber material, such as one that comprises ethylene propylene diene monomer. In other embodiments, the mask's body comprises a combination of a rigid body formed from molded plastic, together with an elastomeric component that is disposed such that when a user wears the mask, the elastomeric component contacts both the mask's rigid body and the user's face.

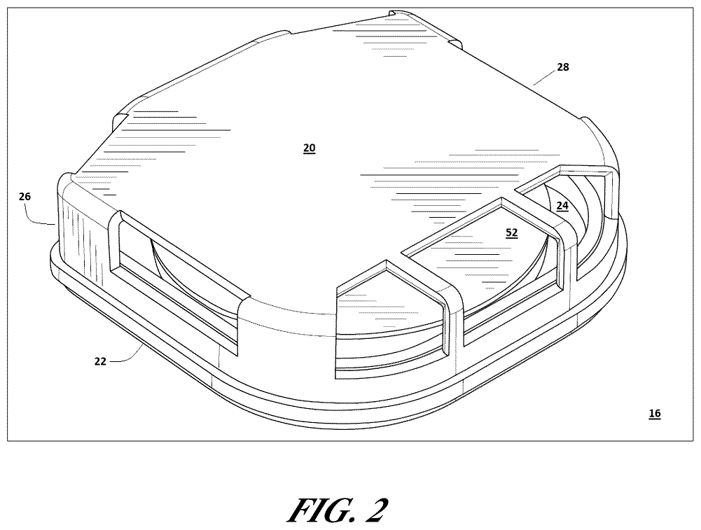

As shown in FIGS. 2 and 3, the exhalation valve 16 features a cover 20, a flexible exhalation-diaphragm 52 (referred to herein as a “diaphragm” to promote brevity), a sealing base 22, and a valve-seating body 24 held therebetween.

For ease of exposition, it is useful to define a right-hand cylindrical coordinate system having its longitudinal axis passing through the center of the valve-seating body 24. Proceeding “upwardly” from the valve-seating body 24, one encounters the cover 20. Proceeding “downwardly” form the valve body 24, one encounters the sealing base 22.

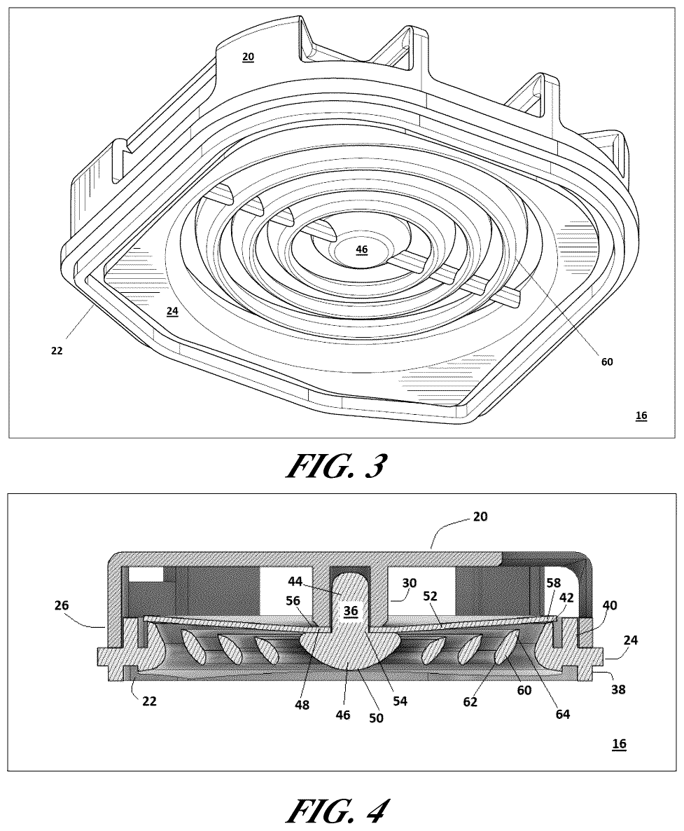

The cover 20 comprises a cover side-wall 26 that extends downward. Windows 28 disposed at regular angular intervals along the circumferential direction allow exhaled air to escape. At its center, the cover 20 extends downward toward the base 22 to form a cylindrical receptacle 30, as shown in FIG. 4. As shown in FIG. 4, the valve body 24 features a spindle 36 disposed at its center. In addition, the valve body 24 includes an outer wall 38 located at a first radius from the spindle 36, an inner wall 40 located at a second radius from the spindle 36, and a valve seat 42 located at a third radius from the spindle 36. The second radius is smaller than the first radius but greater than the third radius.

The outer wall 38 extends downward; the inner wall 40 and the valve seat 42 extend upward. When the exhalation valve 16 is assembled, the valve body's outer wall 38 supports the sidewall 26 of the cover 20 and the valve body's inner wall 40 contacts an inner surface of the cover's sidewall 26, thereby preventing the cover 20 from shifting in either the radially inward or the radially outward direction.

FIG. 4 also shows a cross-section of an embodiment in which the diaphragm 52 has a central hole 54. The diaphragm 52 further comprises a clamped region 56 and a valve face 58. The clamped region 56 is an annular region that surrounds the central hole 54. The valve face 58 is a region at the diaphragm's periphery.

The spindle 36 comprises a shaft 44 that protrudes upward towards the cover 20 and a foot 46 that protrudes downward towards the base 22. The foot 46 comprises an annular ledge 48. The shaft 44 protrudes through the diaphragm's central hole 54 and up into the cover's receptacle 30. In this configuration, the foot's annular ledge 48 and the receptacle's distal end cooperate to clamp the diaphragm 52 at its clamped region 56. Meanwhile, the diaphragm's valve face 58 rests on the valve seat 42.

In response to a force due to exhalation pressure, the diaphragm's valve face 58 lifts off the valve seat 42, thus opening the exhalation valve 16. In the absence of such a force, the valve face 58 rests on the valve seat 42, thus closing the exhalation valve 16.

Referring now to FIGS. 3 and 4, the valve body 24 also features annular vanes 60 that are concentric with the spindle's shaft 32. Each annular vane 60 therefore has a different radius.

The cross section of each annular vane 60 has a leading edge 62, which is closest to the base 22, and a trailing edge 64, which is closest to the diaphragm 52. This results in vanes 60 whose cross section has a shape similar to an airfoil.

The leading edges 60 of the vanes 60 are aligned on an imaginary horizontal plane. In contrast, the trailing edges 64 of the vanes 60 are aligned along an imaginary convex surface. As a result, the trailing edges 64 are not all the same distance from the diaphragm 52. In particular, the distance between the diaphragm 52 and the trailing edges 64 of the vanes 60 decreases monotonically as the radii of the vanes 60 increase.

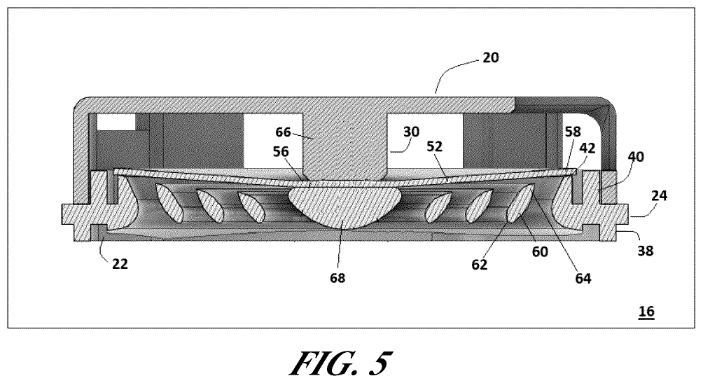

In an alternative embodiment, shown in FIG. 5, a pin 66 that projects downwardly from the cover 20 toward the diaphragm 52 replaces the cylindrical receptacle 30. The pin 66 presses the diaphragm 52 against an anvil 68. As a result, the diaphragm 52 is securely retained it between a distal end of the pin 31 and the anvil 68. In this embodiment, the diaphragm 52 no longer requires a hole 54 to accommodate the shaft 44 as did the diaphragm 52 shown in FIG. 4. Among these embodiments are those in which the cylindrical housing or pin imparts a slight concave curvature to the diaphragm 52 so as to impart a force that causes the diaphragm 52 to maintain an airtight position on the valve-seat 42 when the user is not exhaling.

In the embodiment shown in FIG. 5, the clamped region 56 is the region of the diaphragm 52 sandwiched between the distal end of the pin 66 and the anvil 68. The valve face 58 is a region at the diaphragm's periphery. By causing the elevation of the clamped region 56 to be below what of the valve seat 42, it is possible to achieve the concavity in the diaphragm's curvature.

Among the embodiments are those in which the diaphragm 52 is circular. These include embodiments in which the valve face 58 is along the diaphragm's circumference. In other embodiments, the diaphragm 52 is a quadrilateral, such as a square, rectangle or a rectangle with a radius at one end. In such embodiments, the valve face 58 is along the diaphragm's perimeter.

The mask 10 defines an interior compartment, which lies between the wearer's face and the mask, and the exterior environment lies outside the interior compartment. A wearer who exhales into the mask adds more air into the interior compartment. Therefore, the pressure in the interior compartment rises by an amount referred to herein as the “exhalation pressure” When added to the ambient pressure, this exhalation pressure rises past a threshold value. At that point, there is enough force to lift the valve face 58 at the diaphragm's periphery off the valve seat 42, thus opening the exhalation valve 16.

In the absence of any structures within the valve body 24, the density of air would be essentially uniform throughout the interior compartment. As a result, the force due to the additional pressure in the interior compartment would be expected to be uniform across the diaphragm 52.

The vanes 60 redistribute this force so that it is no longer spatially uniform. This redistribution of force allows the exhalation valve 16 to open at a pressure threshold that is lower than would otherwise be required in the absence of the vanes 60.

The redistribution of forces effected by the vanes 60 takes advantage of the observation that the diaphragm 52, having been clamped only in the claimed region 56 around the central hole 54, is a cantilevered structure. Thus, what actually opens the exhalation valve 16 is not the force itself but a torque developed by that force. This torque depends on the moment arm at which the force is applied.

By concentrating the applied force at the valve face 58, the vanes 60 direct the force to where the moment arm is greatest. As a result, it is possible to lift the valve face 58 off the valve seat 42 with less force, thus making the exhalation valve 16 open at a lower pressure.

What is claimed is:

1. An apparatus comprising an exhalation valve that remains closed until opened in response to exhalation pressure caused by a pulse of exhaled air, wherein said exhalation valve comprises: a cover, a base that engages said cover, a valve body that is between said cover and said base, and a cantilevered diaphragm having a clamped region and a valve face, said valve face comprising a plurality of regions, each of which defines a moment arm, wherein said plurality of regions comprises a particular region that defines a moment arm that is longer moment arms of all other regions, wherein said clamped region is clamped at said valve body, wherein said valve face is free to deform in response to said exhalation pressure, wherein said valve body comprises: a valve seat that is disposed on said valve body and that faces said valve face and a plurality of vanes, said vanes being configured to cause a pressure field that results from said exhalation pressure to have an average pressure gradient that points toward said valve seat and said particular region of said valve face, and wherein, in the absence of exhalation-induced torque at said valve face that is above a threshold, said valve face contacts said valve seat and closes said exhalation valve, and wherein, in response to exhalation-induced torque above said threshold, said valve seat lifts off said valve seat and opens said exhalation valve.

2. The apparatus of claim 1, wherein said clamped region surrounds a hole in said diaphragm and said valve face is disposed along a periphery of said diaphragm.

3. The apparatus of claim 1, wherein said valve body comprises a spindle having a shaft and an annular ledge around said shaft, wherein said base forms a receptacle that receives said shaft, and wherein said diaphragm is clamped between said annular ledge and a distal end of said receptacle.

4. The apparatus of claim 1, wherein said vanes are annular vanes that are concentric with each other.

5. The apparatus of claim 1, wherein each of said vanes follows a path that, when projected on said diaphragm, results in a closed path on said diaphragm.

6. The apparatus of claim 1, wherein said vanes comprise a cross section having a leading edge and a trailing edge, wherein said trailing edge is closer to said diaphragm than said leading edge.

7. The apparatus of claim 1, wherein each of said vanes has a cross section having a major axis and a minor axis, wherein said major axis is disposed along a direction that has a component that is directed toward said diaphragm.

8. The apparatus of claim 1, wherein said vanes are annular vanes having leading edges and trailing edges, and wherein said leading edges of said vanes are tangent to a common plane.

9. The apparatus of claim 1, wherein each of said vanes is separated from said diaphragm by a vertical distance, and wherein said vertical distances are non-uniform.

10. The apparatus of claim 1, wherein each of said vanes comprise a first vane and a second vane, wherein said first vane is closer to said valve face than said second vane, wherein said first vane is separated from said diaphragm by a first distance, wherein said second vane is separate from said diaphragm by a second distance, and wherein said second distance is greater than said first distance.

11. The apparatus of claim 1, wherein vanes that are closer to said valve seat are also closer to said diaphragm.

12. The apparatus of claim 1, wherein said vanes are oriented to prevent exhaled air from impinging directly on said diaphragm.

13. The apparatus of claim 1, wherein said vanes are oriented to direct exhaled air away from said clamped region of said diaphragm.

14. The apparatus of claim 1, wherein said diaphragm defines a plurality of moment arms and wherein said vanes are configured to cause exhaled air to travel towards those moment arms that are the longest of the plurality of moment arms.

15. The apparatus of claim 1, wherein said vanes are configured to direct exhaled air to maximize torque applied to said valve face.

16. The apparatus of claim 1, wherein said vanes are configured to increase density of exhaled air at a periphery of said valve body.

17. The apparatus of claim 1, wherein said vanes comprise leading edges that are aligned to be coplanar with a horizontal plane and trailing edges that are aligned to follow a convex surface.

18. The apparatus of claim 1, wherein said vanes have edges that delineate a cylindrical volume formed by a cylindrical section bounded by a plane perpendicular to an axis of said cylindrical section and by a concave surface.

19. The apparatus of claim 1, wherein said clamped region surrounds a hole in said diaphragm.

20. The apparatus of claim 1, wherein said diaphragm is circular.

21. The apparatus of claim 1, further comprising a face mask, wherein said exhalation valve is disposed on said face mask and wherein said exhalation pressure results from respiration by a person who is wearing said face mask.

22. An apparatus comprising a mask and an exhalation valve disposed on said mask, wherein said exhalation valve opens in response to exhalation pressure caused by exhalation into said mask, wherein said exhalation valve comprises means for housing a valve body and a cantilevered diaphragm having a flexible periphery, wherein said valve body comprise means for directing exhaled air towards said periphery of said diaphragm.

23. The apparatus of claim 1, wherein said clamped region surrounds a central clamping member in said diaphragm and said valve face is disposed along a periphery of said diaphragm.

24. The apparatus of claim 1, wherein said particular region comprises a periphery of said diaphragm.

25. The apparatus of claim 1, wherein said vanes are configured to increase density of exhaled air at said particular region.
